(19) United States
(12) Patent Application Publication
(10) Pub. No.: US 2026/0024702 A1
(43) Pub. Date: Jan. 22, 2026

(54) MOUNTING STRUCTURE OF ELECTRONIC COMPONENT

(71) Applicant: Murata Manufacturing Co., Ltd., Kyoto-fu (JP)

(72) Inventor: Sayaka HIOKI, Nagaokakyo-shi (JP)

(73) Assignee: Murata Manufacturing Co., Ltd., Kyoto-fu (JP)

(21) Appl. No.: 19/261,478

(22) Filed: Jul. 7, 2025

(30) Foreign Application Priority Data
Jul. 16, 2024 (JP) 2024-113556

(51) Int. Cl. H01G 4/232; H01G 4/008; H01G 4/012; H01G 4/12; H01G 4/248; H01G 4/30

(52) U.S. Cl. CPC H01G 4/2325; H01G 4/008; H01G 4/012; H01G 4/248; H01G 4/30; H01G 4/1227

(57) ABSTRACT

In the mounting structure of an electronic component, an alloy having a Ni component included in each external electrode and the land of the substrate and a Sn component included in the solder is generated in the production process. A mounting structure of an electronic component includes a substrate having a land, a capacitor component having a first external electrode stacked on an outer surface of a base body, and a solder including Sn. At least one of the first external electrode and the land contains Ni. The first external electrode is bonded to the land with the solder. The solder contains the Cu-containing particles, and has a portion protruding outward with respect to the outer edge of the capacitor component when viewed from a direction orthogonal to the substrate. The particles are located between the first external electrode and the land and in the protruding portion.

### CROSS-REFERENCE TO RELATED APPLICATION

This application claims benefit of priority to Japanese Patent Application No. 2024-113556, filed Jul. 16, 2024, the entire content of which is incorporated herein by reference.

### BACKGROUND

### Technical Field

The present disclosure relates to a mounting structure of an electronic component.

### Background Art

Japanese Patent Application Laid-Open No. 2022-111361 discloses a structure in which a multilayer ceramic capacitor is mounted on a land of a substrate by soldering. The multilayer ceramic capacitor of Japanese Patent Application Laid-Open No. 2022-111361 includes a dielectric layer, a plurality of internal electrode layers, and an external electrode. Each internal electrode extends inside the dielectric layer. In addition, the end portion of each internal electrode is exposed from the surface of the dielectric layer. The external electrode is stacked on the surface of the dielectric layer.

### SUMMARY

In the mounting structure of an electronic component as described in JP 2022-111361 A, an alloy having a Ni component included in each external electrode and the land of the substrate and a Sn component included in the solder is generated in the production process. The alloy may grow thick, for example, by being exposed to high heat. The alloy is hard and brittle, and thus the alloy grows thick in the mounting structure, which may cause a decrease in bonding strength of the electronic component to the land of the substrate.

Accordingly, the present disclosure provides a mounting structure of an electronic component including a substrate having a land; an electronic component having a base body and an external electrode stacked on an outer surface of the base body; and solder including Sn. At least one of the external electrode and the land contains Ni. The external electrode is bonded to the land by the solder. The solder contains particles including Cu, and has a portion protruding outward with respect to an outer edge of the electronic component when viewed in a direction orthogonal to the substrate, and the particles are located between the external electrode and the land and in the protruding portion.

The present disclosure can suppress a decrease in bonding strength of an electronic component to a land of a substrate.

### BRIEF DESCRIPTION OF THE DRAWINGS

FIG. 1 is a partial sectional perspective view of a capacitor component;

FIG. 2 is a partial sectional view of a mounting structure of a capacitor component;

FIG. 3 is a schematic view illustrating a substrate preparation step;

FIG. 4 is a schematic view illustrating a solder application step;

FIG. 5 is a schematic view illustrating an implementing step; and

FIG. 6 is a schematic view illustrating a heating step.

### DETAILED DESCRIPTION

Hereinafter, an embodiment of applying the present disclosure to a capacitor component 10 as an electronic component will be described with reference to the drawings. It is to be noted that components may be shown in an enlarged manner for easy understanding in the drawings. Dimensional ratios of the components may be different from actual ones or those in another drawing.

### <Capacitor Component>

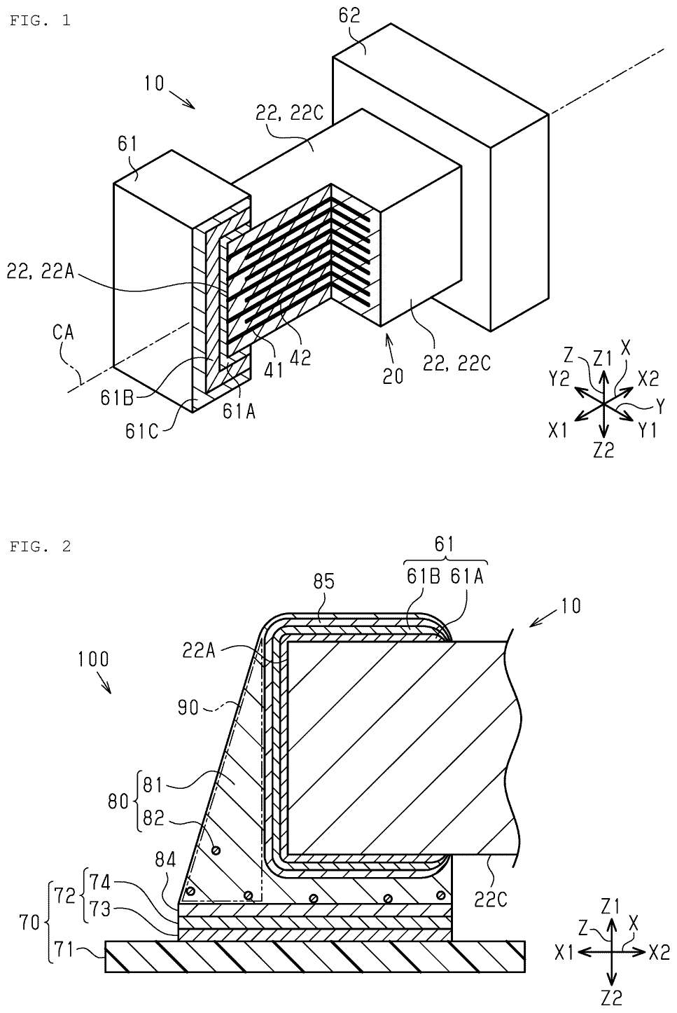

As illustrated in FIG. 1, the capacitor component 10 is a multilayer ceramic capacitor. The capacitor component 10 includes a base body 20. In FIG. 1, in order to illustrate the internal structure, a part of the capacitor component 10 is illustrated in a state of being virtually cut out. The base body 20 has a rectangular parallelepiped shape and has a central axis CA. Hereinafter, an axis extending along the central axis CA is defined as a first axis X. In addition, one of axes that are orthogonal to the first axis X is defined as a second axis Y. Further, an axis that is orthogonal to the first axis X and the second axis Y is defined as a third axis Z. Furthermore, one of the directions along the first axis X is defined as a first positive direction X1, and the direction opposite to the first positive direction X1, of the directions along the first axis X, is defined as a first negative direction X2. In addition, one of the directions along the second axis Y is defined as a second positive direction Y1, and the direction opposite to the second positive direction Y1, of the directions along the second axis Y, is defined as a second negative direction Y2. Further, one of the directions along the third axis Z is defined as a third positive direction Z1, and a direction opposite to the third positive direction Z1, of the directions along the third axis Z, is defined as a third negative direction Z2.

The outer surface of the base body 20 includes six flat faces 22. It is to be noted that the term “surface” of the base body 20 as used herein refers to a part that can be observed as a surface when the whole base body 20 is observed. More specifically, for example, if there are such minute irregularities or steps that fail to be found unless a part of the base body 20 is enlarged and observed with a microscope or the like, the face is expressed as a flat face or a curved face. The six flat faces 22 face in directions different from each other. The six flat faces 22 are roughly divided into a first end surface 22A that faces in the first positive direction X1, a second end surface that faces in the first negative direction X2, and four side surfaces 22C. The four side surfaces 22C are a surface facing the third positive direction Z1, a surface facing the third negative direction Z2, a surface facing the second positive direction Y1, and a surface facing the second negative direction Y2, respectively.

As illustrated in FIG. 1, in the base body 20, the dimension in the direction along the first axis X is larger than the dimension in the direction along the second axis Y and the dimension in the direction along the third axis Z. The material of the base body 20 is a dielectric ceramic. Specifically, the material of the base body 20 contains BaTiO₃ as a main component. Alternatively, the material of the base body 20 may contain CaTiO₃, SrTiO₃, CaZrO₃, or the like as a main component. In addition, the material of the base body 20 may contain a Mn compound, a Co compound, a Si compound, a rare earth compound, or the like as an accessory component.

As shown in FIG. 1, the capacitor component 10 includes five first internal electrodes 41 and four second internal electrodes 42. The first internal electrodes 41 and the second internal electrodes 42 are embedded in the base body 20. In FIG. 1, only a part of the first internal electrodes 41 and a part of the second internal electrodes 42 are denoted by reference numerals.

The material of the first internal electrode 41 is a conductive material. Specifically, the material of the first internal electrodes 41 is Ni. The material of the second internal electrode 42 is the same as the material of the first internal electrode 41.

The first internal electrode 41 has a rectangular plate shape. The first internal electrode 41 has a main surface that is orthogonal to the third axis Z. The second internal electrode 42 has the same rectangular plate shape as the first internal electrode 41. The second internal electrode 42 has a main surface orthogonal to the third axis Z, as with the first internal electrode 41. The main surface herein refers to a flat face having the largest area among the outer surfaces of the plate-shaped object.

The dimension of the first internal electrode 41 in the direction along the first axis X is smaller than the dimension of the base body 20 in the direction along the first axis X. In addition, the dimension of the first internal electrode 41 in the direction along the second axis Y is smaller than the dimension of the base body 20 in the direction along the second axis Y. The dimension of the second internal electrode 42 in each of the directions is substantially the same as the dimension of the first internal electrode 41.

As shown in FIG. 1, the first internal electrode 41 and the second internal electrode 42 are located in a staggered manner in the direction along the third axis Z. That is, the first internal electrode 41, the second internal electrode 42, the first internal electrode 41, and the second internal electrode 42 are disposed in this order from the side surface 22C facing the third positive direction Z1 toward the third negative direction Z2. According to this embodiment, the distances between the respective internal electrodes in the direction along the third axis Z are equal to each other.

As shown in FIG. 1, the five first internal electrodes 41 and the four second internal electrodes 42 are both located at the center of the base body 20 in the direction along the second axis Y. On the other hand, as illustrated in FIG. 1, the first internal electrode 41 is close to the first positive direction X1. Although not illustrated, the second internal electrode 42 is closer to the first negative direction X2.

Specifically, as illustrated in FIG. 1, the end of the first internal electrode 41 on the first positive direction X1 side coincides with the end of the base body 20 on the first positive direction X1 side. Therefore, the end of the first internal electrode 41 on the first positive direction X1 side is exposed at the first end surface 22A. The end of the first internal electrode 41 on the first negative direction X2 side is located inside the base body 20, without reaching the end of the base body 20 on the first negative direction X2 side. On the other hand, although not illustrated, the end of the second internal electrode 42 on the first negative direction X2 side coincides with the end of the base body 20 on the first negative direction X2 side. Therefore, the end of the second internal electrode 42 on the first negative direction X2 side is exposed at the second end surface. The end of the second internal electrode 42 on the first positive direction X1 side is located inside the base body 20, without reaching the end of the base body 20 on the first positive direction X1 side.

As shown in FIG. 1, the capacitor component 10 includes a first external electrode 61 and a second external electrode 62.

The first external electrode 61 covers the first end surface 22A of the base body 20 and parts of the four side surfaces 22C thereof on the first positive direction X1 side. That is, the first external electrode 61 is a five-face electrode. As illustrated in FIG. 2, the first external electrode 61 includes a first base electrode 61A, a first Ni layer 61B, and a first Sn layer 61C. The first base electrode 61A, the first Ni layer 61B, and the first Sn layer 61C are stacked in this order from the outer surface side of the base body 20. In FIG. 2, illustration of each internal electrode inside the base body 20 is omitted.

The first base electrode 61A is laminated at a part of the outer surface of the base body 20, including the first end surface 22A. Specifically, the first base electrode 61A covers the first end surface 22A of the base body 20 and parts of the four side surfaces 22C thereof on the first positive direction X1 side. In the present embodiment, the material of the first base electrode 61A is copper. The first base electrode 61A may contain a polymer compound including inorganic carbon and organic carbon.

The first Ni layer 61B is stacked on the first base electrode 61A. That is, the first Ni layer 61B covers the first base electrode 61A from the outside. The first Ni layer 61B contains Ni as a main component. The first Ni layer 61B is formed by, for example, Ni electroplating. The “main component” means that the content ratio of the target substance exceeds 50%. For example, in the first Ni layer 61B, the content ratio of Ni exceeds 50 mol %. Types of elements present in each layer of the first external electrode 61 and the concentration of each element can be observed by so-called TEM-EDX (energy dispersive X-ray spectroscopy).

The first Sn layer 61C is stacked on the first Ni layer 61B. That is, the first Sn layer 61C covers the first Ni layer 61B from the outside. The first Sn layer 61C contains Sn as a main component. The first Sn layer 61C is formed by, for example, electroplating of Sn.

The second external electrode 62 covers the second end surface of the base body 20 and a part of the four side surfaces 22C on the first negative direction X2 side. That is, the second external electrode 62 is a five-face electrode. The second external electrode 62 does not reach the first external electrode 61 on the side surface 22C, and is separated from the first external electrode 61 in the direction along the first axis X. On the side surface 22C of the base body 20, the central portion in the direction along the first axis X is a portion where the first external electrode 61 and the second external electrode 62 are not stacked.

Although not illustrated, the second external electrode 62 includes a second base electrode, a second Ni layer, and a second Sn layer. The configurations of the second base electrode, the second Ni layer, and the second Sn layer of the second external electrode 62 are similar to the configurations of the first base electrode 61A, the first Ni layer 61B, and the first Sn layer 61C of the first external electrode 61.

### <Mounting Structure of Capacitor Component>

Then, a mounting structure 100 of a capacitor component 10 and a substrate 70 will be described. Hereinafter, the mounting structure of a first external electrode 61 and the substrate 70 of the capacitor component 10 will be described, but the same applies to a mounting structure of a second external electrode 62 and the substrate 70.

As illustrated in FIG. 2, the substrate 70 includes a substrate body 71 and a land 72. The substrate body 71 is made of an insulating material such as synthetic resin. The substrate body 71 has a plate shape. The land 72 is stacked on the main surface of the substrate body 71. The land 72 is a portion for mounting the capacitor component 10 described above. Although not illustrated, the land 72 is connected to wiring or the like extending on the substrate body 71.

The land 72 before mounting the capacitor component 10 includes a base layer 73, a first plating layer 74, and a second plating layer. The base layer 73, the first plating layer 74, and the second plating layer are stacked in this order from the substrate body 71 side. The main component of the base layer 73 is Cu. The main component of the first plating layer 74 is Ni. The main component of the second plating layer is Au. These layers may contain elements other than the element as the main component. Types of elements present in each layer of the land 72 and the concentration of each element can be observed by so-called TEM-EDX.

As shown in FIG. 2, the capacitor component 10 is bonded onto the land 72 of the substrate 70 with the solder 80 interposed therebetween. Specifically, in a state where the capacitor component 10 is mounted on the land 72 of the substrate 70, one surface of the first external electrode 61 of the capacitor component 10 faces the land 72. A part of the solder 80 is interposed between the land 72 and the first external electrode 61 facing the land 72.

Au as a main component of the second plating layer in the land 72 is dispersed in the solder 80 when the capacitor component 10 is mounted on the substrate 70 by the solder 80. Therefore, in a state after the capacitor component 10 is mounted, the second plating layer of the land 72 does not have a clear layer structure and is in a state of being integrated with the solder 80. In contrast, the first alloy layer 84 is generated in the boundary region between the first plating layer 74 and the solder 80. The first alloy layer 84 is an alloy including Cu included in the particles 82 described later, Ni included in the first plating layer 74, and Sn included in the solder 80. The alloy herein is a concept including an intermetallic compound, a solid solution, and one in a eutectic state.

In addition, as described above, the main component of the first Sn layer 61C is Sn. Therefore, when the capacitor component 10 is mounted on the substrate 70 by the solder 80, the first Sn layer 61C is melted together with the solder 80. Therefore, the first Sn layer 61C is integrated with the solder 80 and does not exist as a clear layer. In contrast, the second alloy layer 85 is generated between the first Ni layer 61B and the solder 80. The second alloy layer 85 is an alloy including Cu included in the particles 82 to be described later, Ni included in the first Ni layer 61B, and Sn included in the solder 80.

In addition, when viewed in a direction orthogonal to the main surface of the substrate 70, the land 72 protrudes outward with respect to the outer edge of the first external electrode 61. Specifically, a part of the land 72 is located on the first positive direction X1 side with respect to the first end surface 22A of the first external electrode 61 facing the first positive direction X1. Although not illustrated, a part of the land 72 protrudes from the outer edge of the first external electrode 61 to both sides in the direction along the second axis Y. In other words, when the mounting structure 100 is viewed from a direction orthogonal to the main surface of the substrate 70, a part of the outer peripheral portion of the land 72 is outside the outer peripheral portion of the first external electrode 61. In the outer peripheral portion of the land 72, there may be a portion disposed inside the outer peripheral portion of the first external electrode 61. Reflecting such a positional relationship between the first external electrode 61 and the land 72, a part of the solder 80 has a fillet portion 90 protruding from the outer edge of the capacitor component 10. In other words, when the mounting structure 100 is viewed from a direction orthogonal to the main surface of the substrate 70, the fillet portion 90, which is a part of the solder 80, exists in a portion outside the outer peripheral portion of the first external electrode 61 in the outer peripheral portion of the land 72. This fillet portion 90 is in contact with the first end surface 22A of the first external electrode 61 and the side surface 22C of the first external electrode 61 facing the direction along the second axis Y. The fillet portion 90 has a shape that expands toward the land 72.

The solder 80 includes a solder body 81 and a plurality of particles 82. The melting point of the solder body 81 is, for example, 130° C. or more and 200° C. or less (i.e., from 130° C. to 200° C.). The melting point of the particles 82 may be more than the melting point of the solder body 81. The melting point of Cu is 1084° C. In FIG. 2, only a part of particles 82 are denoted by reference numerals. The main component of the solder body 81 is an alloy including Sn and Bi. Specifically, the material of the solder body 81 is Sn-58Bi. The main component of the particles 82 is Cu. That is, the particles 82 are copper particles. The particle size of the particle 82 is 7.5 μm or more and 30 μm or less (i.e., from 7.5 μm to 30 μm) in terms of a median size. The content of the Cu component in the particles 82 in the solder 80 is 0.01 wt % or more and 10 wt % or less (i.e., from 0.01 wt % to 10 wt %) with respect to the total weight of the solder 80. In the direction parallel to the main surface of the land 72, the particles 82 are distributed over the entire land 72 in the solder 80. Therefore, the particles 82 exist not only between the first external electrode 61 and the land 72 but also in the fillet portion 90 of the solder 80.

### <Method for Producing Mounting Structure>

The method for producing the mounting structure 100 includes a substrate preparation step, a solder application step, an implementing step, and a heating step.

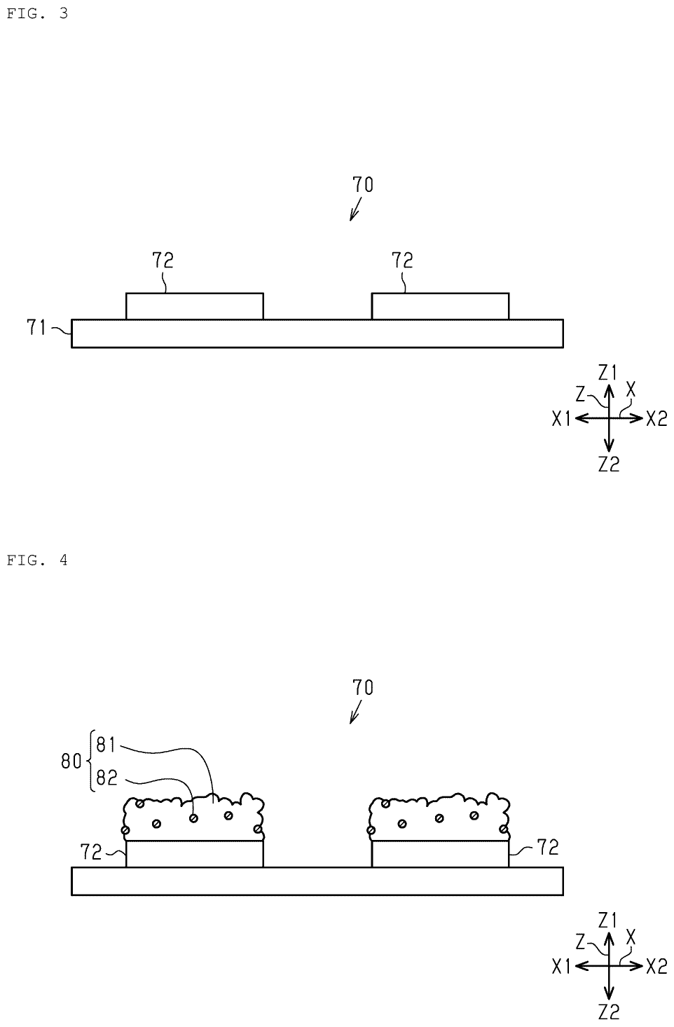

First, as illustrated in FIG. 3, a substrate preparation step is performed. In the substrate preparation step, the substrate 70 is placed at a predetermined position. The substrate 70 has a pair of lands 72 for one capacitor component 10 to be mounted. The pair of lands 72 are disposed at intervals in a direction parallel to the main surface of the substrate body 71. The interval between the pair of lands 72 is shorter than the distance from the first end surface 22A to the second end surface of the capacitor component 10 in the direction along the first axis X. In addition, the area of the main surface of each land 72 is larger than the area of the surface of the capacitor component 10 facing the third negative direction Z2 side of the first external electrode 61.

Then, as illustrated in FIG. 4, a solder application step is performed. In the solder application step, a solder paste including a solder 80 is applied onto each land 72 on the substrate 70. In this embodiment, a solder paste including the solder 80 is applied to the entire main surface of each land 72. The solder paste is prepared by mixing and stirring a particulate solder body 81 including Sn-58Bi, which is a base of the solder 80, the particles 82, a flux, a thixotropic agent, and the like. The content of the Cu component in the particles 82 in the solder 80 is 0.01 wt % or more and 10 wt % or less (i.e., from 0.01 wt % to 10 wt %) with respect to the total weight of the solder 80. The particle size of the particle 82 is 7.5 μm or more and 30 μm or less (i.e., from 7.5 μm to 30 μm) in terms of a median size.

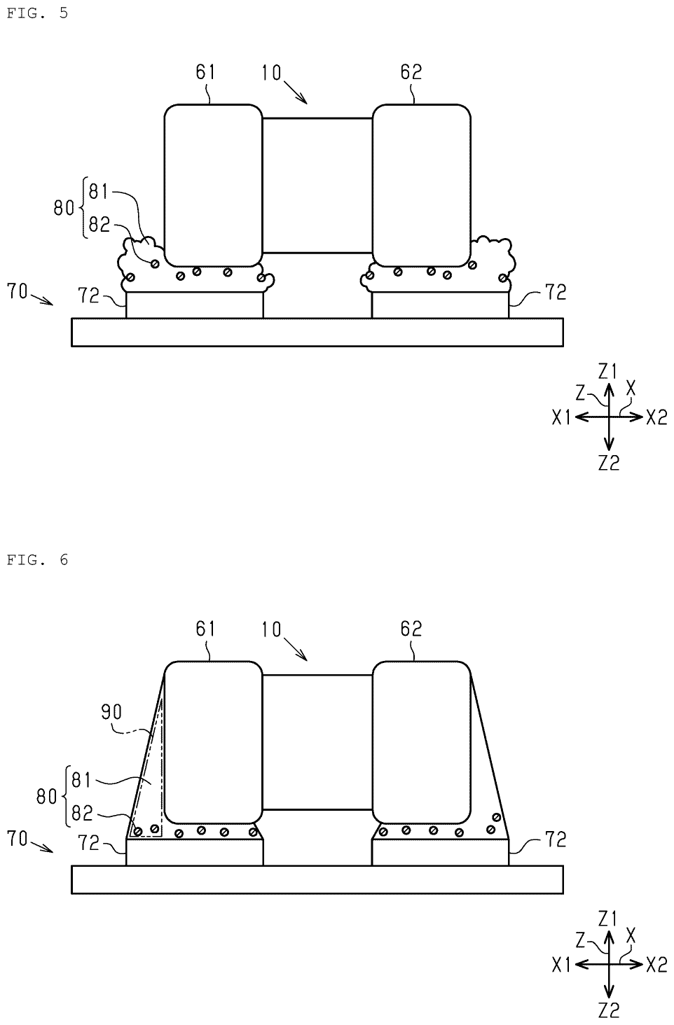

Then, as illustrated in FIG. 5, the implementing step is performed. In the implementing step, the capacitor component 10 is placed on the pair of lands 72. Specifically, the first external electrode 61 is placed on the main surface of one land 72, and the second external electrode 62 is placed on the main surface of the other land 72. As described above, the solder paste including the solder 80 is already applied onto each land 72, and thus the solder 80 is interposed between each land 72 and the capacitor component 10 in a state where the capacitor component 10 is placed in the implementing step.

Then, as illustrated in FIG. 6, the heating step is performed. In the heating step, the solder 80 is heated to be melted. Specifically, the entire substrate 70 and capacitor component 10 are heated in a heating furnace. The heating temperature in this case is a temperature at which the solder 80 is melted and the particles 82 are not melted. The maximum heating temperature is set within a range of 150° C. or more and 210° C. or less (i.e., from 150° C. to 210° C.), for example. When the solder 80 is melted at this temperature, the particles 82 settle toward the land 72 by their own weight. For this reason, the particles 82 on each land 72 are more on the side closer to each land 72 in the solder 80. In other words, the particles 82 are unevenly distributed on the land 72 side. In addition, when the solder 80 is melted, the solder wets and spreads on the surface of the first external electrode 61 facing the first positive direction X1, the surface thereof facing the second positive direction Y1, and the surface thereof facing the second negative direction Y2. As a result, the fillet portion 90 of the solder 80 is formed. Similarly, the fillet portion 90 is also formed in the second external electrode 62.

### <Comparative Test>

Results of tests on fixing strength and impact resistance of the capacitor component will be described. Samples of mounting structures of specimen numbers 1, 2, 3, 4, and 5 described below were subjected to the test. The structure and material of these samples conform to the structure and material of the mounting structure 100 of the above embodiment unless otherwise specified. In addition, specimen numbers 1 and 5 are samples prepared for comparison.

TABLE 1

| | | | | 125° C. | 125° C. |
|---|---|---|---|---|---|
| | | | | 100 h | 500 h |
| | | | | After being | After being |
| | | | | left to stand | left to stand |
| Specimen | Solder | Land surface | | Fixing | Impact |
| number | composition | treatment | Cu content | strength | resistance |
| 1 | Sn-58Bi | Ni/Au | Owt % Cu | B | C |
| 2 | Sn-58Bi | Ni/Au | 1 wt % Cu | A | A |
| 3 | Sn-58Bi | Ni/Au | 2 wt % Cu | A | A |
| 4 | Sn-58Bi | Ni/Au | 5 wt % Cu | A | A |
| 5 | Sn-58Bi | Cu | Owt % Cu | B | B |

As shown in Table 1, in the samples of specimen numbers 1, 2, 3, 4, and 5, the material of the solder is Sn-58Bi. Among the samples of specimen numbers 1, 2, 3, 4, and 5, in the samples of specimen numbers 2, 3, and 4, the solder contains Cu particles. In the samples of specimen numbers 2, 3, and 4, the particle sizes of the Cu particles in the solder are all 7.5 μm in median size. In the sample of specimen number 2, the content of Cu particles in the solder is 1 wt % with respect to the weight of the entire solder. In the sample of specimen number 3, the content of Cu particles in the solder is 2 wt % with respect to the weight of the entire solder. In the sample of specimen number 4, the content of Cu particles in the solder is 5 wt % with respect to the weight of the entire solder. In the samples of specimen numbers 1 and 5, the content of Cu particles in the solder is 0%. In the samples of specimen numbers 1, 2, 3, and 4, the land of the substrate has a two-layer structure of a plating layer containing Ni as a main component and a plating layer containing Au as a main component in order from the substrate body side. In the sample of specimen number 5, the land of the substrate has a single-layer structure including a plating layer containing Cu as a main component.

In this test, samples of specimen numbers 1, 2, 3, 4, and 5 were exposed to an atmosphere of 125° C. for 100 hours. Thereafter, in each sample, how much the bonding strength of the capacitor component to the substrate was reduced as compared with the initial state was examined. Herein, the “initial state” refers to a state before each mounting structure is exposed to an atmosphere of 125° C. In this comparative test, the bonding strength of the capacitor component to the substrate was evaluated from two viewpoints of fixing strength and impact resistance.

A method for evaluating fixing strength in this comparative test will be described. The fixing strength in this comparative test is a load required for breaking the mounting structure when a load is applied to the capacitor component from a direction parallel to the main surface of the substrate. Herein, the breaking of the mounting structure means that the substrate cannot be connected to the land because breaking occurs in any of the component, the bonding material, and the land. A case where the fixing strength of each mounting structure after being exposed to a high temperature of 125° C. for 100 hours is 95% or more of the fixing strength in the initial state is evaluated as A. A case where the fixing strength of each mounting structure after being exposed to a high temperature of 125° C. for 100 hours is 70% or more and less than 95% (i.e., from 70% to less than 95%) of the fixing strength in the initial state is evaluated as B. A case where the fixing strength of each mounting structure after being exposed to a high temperature of 125° C. for 100 hours is less than 70% of the fixing strength in the initial state is evaluated as C.

A method for evaluating impact resistance in this comparative test will be described. The impact resistance in this comparative test is a ratio of the mounting structure in which the electronic component did not fall off in the population of the mounting structures after a predetermined impact was applied 1000 times. A case where the impact resistance of each mounting structure after being exposed to a high temperature of 125° C. for 500 hours is 95% or more of the impact resistance in the initial state is evaluated as A. A case where the impact resistance of each mounting structure after being exposed to a high temperature of 125° C. for 500 hours is 70% or more and less than 95% (i.e., from 70% to less than 95%) of the impact resistance in the initial state is evaluated as B. A case where the impact resistance of each mounting structure after being exposed to a high temperature of 125° C. for 500 hours is less than 70% of the impact resistance in the initial state is evaluated as C.

According to this comparative test, the mounting structures of specimen numbers 2, 3, and 4 were all evaluated as A in terms of fixing strength and impact resistance. In contrast, the mounting structures of specimen numbers 1 and 5 were all evaluated as B or lower in terms of fixing strength and impact resistance. That is, the Cu particles present in the solder of the mounting structure suppress a decrease in bonding strength between the substrate of the mounting structure and the electronic component after being exposed to a high temperature.

### Effects of Embodiment

The advantageous effects of the present embodiment will be described.

(1) In the above embodiment, the Ni component is included in each external electrode of the capacitor component 10 and the land 72 of the substrate 70. Therefore, the Ni component and Sn included in the solder 80 are alloyed in the production process. This Ni—Sn alloy grows thick as the substrate 70 and the capacitor component 10 are exposed to a high temperature. The Ni—Sn alloy is brittle compared to the solder body 81 of the solder 80, and thus when the Ni—Sn alloy layer is formed thick, the bonding strength of the capacitor component 10 to the substrate 70 decreases.

In this respect, the particles 82 in the solder 80 are distributed not only between each external electrode of the capacitor component 10 and the land 72 of the substrate 70 but also over the entire main surface of the land 72. Then, Cu as a main component of the particles 82 suppresses the growth of the above-described Ni—Sn alloy. Therefore, according to the above embodiment, a decrease in reliability of bonding between the land 72 and the capacitor component 10 is suppressed.

(2) The Cu particles or the Cu compound particles are present under the product electrode or in the vicinity of the land, thereby allowing the solder thickness under the product electrode to be secured, and thus improving the bonding reliability.

(3) In the above embodiment, Cu included in the particles 82 does not melt in the solder 80, but exists in the solder 80 as the particles 82. This makes it possible to provide the effect of Cu while maintaining the bonding reliability. In addition, the particles 82 are unevenly distributed near the land, and thus the effect of improving the bonding reliability can be efficiently obtained despite of a small blending amount.

(4) Setting the content of the Cu component of the particles 82 in the solder 80 to 0.01 wt % or more with respect to the weight of the entire solder 80 causes the particles 82 to be easily spread over the entire land 72. Therefore, it is possible to appropriately provide the effect of suppressing the decrease in the bonding strength described above. In contrast, when the content of the Cu component in the particles 82 in the solder 80 is more than 10 wt % with respect to the weight of the entire solder 80, an excessively large amount of particles 82 may be exposed on the surface of the solder 80 after mounting of the capacitor component 10. Such an exposure of a large amount of particles 82 causes a concern of adversely affecting the bonding strength of the solder body 81. As in the above embodiment, when the content of the Cu component in the particles 82 is 10 wt % or less, there is a low possibility that such a concern will become apparent.

(5) Setting the particle size of the particle 82 to 7.5 μm or more sufficiently secures the effect of maintaining the bonding reliability between the substrate 70 and the capacitor component 10. In addition, when the particle size of the particle 82 is larger than 30 μm, the solder bonding portion between the substrate 70 and the capacitor component 10 may become unstable depending on the sizes of the capacitor component 10 and the land 72. Therefore, the particle size of the particles 82 is preferably 7.5 μm or more and 30 μm or less (i.e., from 7.5 μm to 30 μm).

### Modification Examples

The present embodiment can be modified and implemented as follows. The present embodiment and the following modification examples can be carried out in combination with each other within a range not technically contradictory.
The shape of the base body 20 is not limited to a rectangular parallelepiped.
The first external electrode 61 is not limited to the five-face electrode as shown in the example of the above embodiment. For example, there may be a side surface 22C that does not include the first external electrode 61. For example, the first external electrode 61 may not include the first end surface 22A. Regardless of the shape of the first external electrode 61, the electrical connection between the land 72 and the capacitor component 10 may be secured. In this respect, the same applies to the second external electrode 62.
In the above embodiment, the example in which the capacitor component 10 is adopted as the electronic component has been described, but the type of the electronic component is not limited to the multilayer ceramic capacitor. As long as the electronic component includes the base body 20 and the external electrode, the configuration related to the particles 82 of the solder 80 of the above embodiment can be applied. Examples of this type of the electronic component include a piezoelectric component, a thermistor, and an inductor. In addition, the base body 20 of the electronic component is not limited to one including a dielectric, and may include, for example, a magnetic body or a piezoelectric body.
The numbers of the first internal electrodes 41 and the second internal electrodes 42 are not limited to the example of the embodiment mentioned above. The number of the first internal electrodes 41 may be less than or more than five. In this respect, the same applies to the second internal electrodes 42.
The particles 82 may have a central portion and a Cu coating layer covering the central portion. In such a case, the material of the central portion may be a metal other than Cu, ceramic, or the like. However, the melting point of the particles 82 is preferably higher than the melting point of Cu. As described above, the amount of Cu used can be reduced by replacing the material in the central portion of the particles 82 with a material other than Cu.
The particles 82 may be particles including Cu, such as copper compound particles, rather than pure copper particles. The copper compound particles are, for example, Cu—Sn alloys such as Cu₆Sn₅ and Cu₃Sn.
The composition of the particles 82 may change before and after heating. A part of or all of the Cu component of the particles 82 may be alloyed with the Sn component of the solder body 81 by heating in the heating furnace. In such a case, the particles 82 may be replaced with particles of an alloy of a Cu component and a Sn component. In addition, two-layer particles of the particles 82 and the alloy of the Cu component and the Sn component may be present. That is, the solder 80 may have particles including Cu. The same applies to the case where the Cu component of the particles 82 is alloyed with a metal component other than Sn.
The material of the solder body 81 is not limited to Sn-58Bi as long as it includes Sn. For example, the solder body 81 may have different Bi contents or may include one or more different elements. The different element is, for example, Ag, Au, Sb, Zn, In, Co, Cu, Pb, or Ni. In the solder body 81, the content of Sn in the solder body 81 is preferably 40 wt % or more and 70 wt % or less (i.e., from 40 wt % to 70 wt %).
The particle size of the particles 82 may be less than 7.5 μm or more than 30 μm in terms of a median size.
Main components of the first plating layer 74 and the second plating layer 75 of the land 72 are not limited to the example of the present embodiment. The main component of the first plating layer 74 may not be Ni. In addition, the main component of the second plating layer 75 may not be Au. The electrical connection between the land 72 and the electronic component may be secured. Any one of the land 72 and the first external electrode 61 includes Ni, an alloy of Sn and Ni derived from the solder 80 is generated, which may cause a problem of reducing the bonding strength.
The main component of the base layer 73 of the land 72 is not limited to the example of the present embodiment.
The material of the first external electrode 61 is not limited. In addition, the first external electrode 61 may have a single-layer structure and a double-layer structure, or may have a multilayer structure of four or more layers. In this respect, the same applies to the second external electrode 62.
The content of the Cu component in the particles 82 in the solder 80 may be less than 0.01 wt % and more than 10 wt % with respect to the weight of the entire solder 80.
There may be no distinct fillet portion 90 in the mounting structure 100. The solder 80 may have a portion protruding from the outer edge of the capacitor component 10 if the shape does not expand toward the substrate 80 side as in the fillet portion 90 of the present embodiment. In this respect, the same applies to the second external electrode 62.
The region where the fillet portion 90 exists is not limited to the example of the present embodiment. When viewed from a direction orthogonal to the main surface of the substrate 70, the fillet portion 90 may exist in one or more directions selected from the first positive direction X1, the second positive direction Y1, and the second negative direction Y2.

### Supplementary Note

A technical idea that can be grasped from the above embodiment and modifications will be described.

[1] A mounting structure of an electronic component includes a substrate having a land; an electronic component having a base body and an external electrode stacked on an outer surface of the base body; and solder including Sn. At least one of the external electrode and the land contains Ni. The external electrode is bonded to the land by the solder. The solder contains particles including Cu, and has a portion protruding outward with respect to an outer edge of the electronic component when viewed in a direction orthogonal to the substrate, and the particles are located between the external electrode and the land and in the protruding portion.

[2] The mounting structure of an electronic component according to [1], wherein the particles include a central portion and a Cu coating layer covering the central portion.

[3] The mounting structure of an electronic component according to [1] or [2], wherein a content of a Cu component in the particles in the solder is 0.01 wt % or more and 10 wt % or less (i.e., from 0.01 wt % to 10 wt %) with respect to a weight of the entire solder.

[4] The mounting structure of an electronic component according to any one of [1] to [3], wherein a size of the particles is 7.5 μm or more and 30 μm or less (i.e., from 7.5 μm to 30 μm).

[5] The mounting structure of an electronic component according to any one of [1] to [4], wherein the base body has a rectangular parallelepiped shape, the land includes Ni and Au, the external electrode includes Ni and Sn, the external electrode is provided on an entire one end surface and one or more surfaces selected from four side surfaces adjacent to the end surface among six flat faces constituting an outer surface of the base body, and the solder includes Sn and Bi.

What is claimed is:

1. A mounting structure of an electronic component comprising:
a substrate having a land;
an electronic component having a base body and an external electrode stacked on an outer surface of the base body; and
a solder including Sn,
wherein
at least one of the external electrode and the land includes Ni,
the external electrode is bonded to the land by the solder,
the solder includes particles including Cu, and has a portion protruding outward with respect to an outer edge of the electronic component when viewed in a direction orthogonal to the substrate, and
the particles are between the external electrode and the land and in the protruding portion.

2. The mounting structure of an electronic component according to claim 1, wherein
the particles include a central portion and a Cu coating layer covering the central portion.

3. The mounting structure of an electronic component according to claim 1, wherein
a content of a Cu component in the particles in the solder is from 0.01 wt % to 10 wt % with respect to a weight of the entire solder.

4. The mounting structure of an electronic component according to claim 1, wherein
a size of the particles is from 7.5 μm to 30 μm.

5. The mounting structure of an electronic component according to claim 1, wherein
the base body has a rectangular parallelepiped shape,
the land includes Ni and Au,
the external electrode includes Ni and Sn,
the external electrode is on an entire one end surface and one or more surfaces selected from four side surfaces adjacent to the end surface among six flat faces configuring an outer surface of the base body, and
the solder includes Sn and Bi.
